(19) United States
(12) Patent Application Publication
(10) Pub. No.: US 2006/0208849 A1
(43) Pub. Date: Sep. 21, 2006

(54) Signal level switching circuit

(76) Inventors: Toshiro Tojo, Tokyo (JP); Takashi Kaku, Tokyo (JP); Tooru Ogawa, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/548,633

(22) PCT Filed: Mar. 11, 2004
(86) PCT No.: PCT/JP04/03169

§ 371 Date: Sep. 9, 2005

(30) Foreign Application Priority Data
Mar. 13, 2003 (JP) 2003-068400

(51) Int. Cl. H01C 10/36

(52) U.S. Cl. 338/172

(57) ABSTRACT

A signal level switching circuit is provided with input resistors 2a and 2b connected between input terminals 1a and 1b of a signal and output terminals 5a and 5b used to be connected to a reception circuit 6; a switch circuit 3 which has been constituted by a plurality of switching elements and has been connected to the output terminals 5a and 5b; and a voltage dividing resistor 4 for selectively switching/connecting with respect to the input resistors 2a and 2b by this switch circuit 3.

### TECHNICAL FIELD

The present invention relates to a signal level switching circuit for switching levels of signals which are inputted to a reception circuit in order that the levels of the signals may become a predetermined range.

### BACKGROUND ART

In reception circuits for receiving and processing signals such as data and voice signals, levels of these signals must be equal to signal levels within a signal processable range. Also, levels of signals which have been transmitted via transmission paths are different from each other, depending upon structures, transmission conditions, and the like of the transmission paths. As a consequence, generally speaking, such a means is provided at a prestage of a reception circuit for receiving/processing signals transmitted via transmission paths. In the case that a signal level is high, this means attenuates the high signal level so as to control this high signal level to a signal level within a predetermined range, whereas in the case that a signal level is low, this means amplifies the low signal level so as to control this low signal level to a signal level within the predetermined range.

FIG. 4 shows a major arrangement of a conventional signal level switching circuit which is provided at a prestage of a reception circuit. In this drawing, reference numeral 40 indicates a signal level switching circuit; reference numerals 41a and 41b indicate input terminals into which a signal is inputted via a transmission path, or a signal is inputted via a signal transformer; reference numeral 42 indicates an attenuating circuit; reference numeral 43 indicates a switch circuit; reference numerals 44a and 44b indicate voltage dividing circuits; reference numeral 45 indicates an amplifying circuit; reference numerals 46a and 46b indicate output terminals; and also, reference numeral 47 indicates a reception circuit.

The signal level switching circuit 40 provided at the prestage of the reception circuit 47 inputs any one of a signal attenuated by the attenuating circuit 42 and a signal obtained by further subdividing the attenuated signal by the voltage diving circuits 44a and 44b into the amplifying circuit 45 by being switched by the switch circuit 43, and the signal level attenuated by the attenuating circuit 42 is amplified by the amplifying circuit 45, and then, the amplified signal is entered from the output terminals 46a and 46b to the reception circuit 47.

Also, the switch circuit 43 is constituted by a switching element such as a transistor. The switch circuit 43 directly enters the output signal of the attenuating circuit 42 to the amplifying circuit 45, or enters the output signal of the attenuating circuit 42, which has been divided by the dividing circuits 44a and 44b, into the amplifying circuit 45. The switching control operation of this switch circuit 43 is carried out based upon a control signal in response to a judging result made by an internal signal level judging circuit of the reception circuit 47.

FIG. 5 shows a concrete circuit arrangement of the signal level switching circuit shown in FIG. 4. It should be understood that the same reference numerals shown in FIG. 4 will be employed as those for denoting the same circuit elements indicated in FIG. 5. In FIG. 5, reference numerals 51 to 54, 56, 57, 61 to 64, 66, and 67 indicate resistors, and reference numerals 55, 65, 58, and 68 indicate operational amplifiers. FIG. 5 shows such a case that the attenuating circuit 42 in FIG. 4 is arranged by the resistors 51, 52, 61, 62, and the operational amplifiers 55, 65; the voltage dividing circuits 44a, 44b are arranged by the resistors 53, 54, 63, 64; and the amplifying circuit 45 is arranged by the resistors 56, 57, 66, 67, and the operational amplifiers 58, 68.

The switch circuit 43 for performing the switching control operation in response to the control signal supplied from the reception circuit 47 is arranged by, as previously explained, a switching element such as a transistor. Under such a switching connection condition shown in this drawing, this switch circuit 43 directly inputs the output signals of the operational amplifiers 55 and 65 which constitute the attenuating circuit 42 into the operational amplifiers 58 and 68 which constitute the amplifying circuit 45. Also, the output signals of the operational amplifiers 55 and 65 which constitute the attenuating circuit 42, and the signals divided by the resistors 53, 54, 63, and 64, which constitute the voltage dividing circuits 44a and 44b can be switched to be entered to the operational amplifiers 58 and 68 which constitute the amplifying circuit 45 based upon the switching connection control operation of the switch circuit 43.

As a consequence, in the case that a level of a signal entered to the input terminals 41a and 41b is high, if the voltage dividing circuits 44a and 44b are selectively switched and connected by the switch circuit 43, then the signal whose signal level has been reduced can be entered to the reception circuit 47. Also, in the case that level of signal entered to the input terminals 41a and 41b is low, if the attenuating circuit 42 is selectively switched and connected by the switch circuit 43, then the signal whose signal level remains substantially the same can be entered to the reception circuit 47.

Also, in a reception circuit containing an amplifier which amplifies a reception signal, the following arrangement is known (refer to, for example, Japanese Laid-open Patent Application No. Hei-10-303775): That is, since the reception signal is amplified by switching a limiter amplifier and a gain control amplifier in response to the reception signal level, this reception circuit can be properly operated even in such a case that the variation of the reception level is large.

FIG. 6 is an explanatory diagram of a signal level in which both the attenuating circuit 42 and the amplifying circuit 45 in FIG. 4 are omitted, the voltage dividing circuits 44a and 44b are arranged by the resistors 53, 54, 63, and 64, and represents a relationship between a signal level and a power supply voltage range “VL” of the switching element which constitutes the switch circuit 43. In the case that such a signal “a” having a level is inputted and this level exceeds the power supply voltage range “VL” of the switching element which constitutes the switch circuit 43, a signal “b” which has been subdivided by the resistors 53, 54, 63, and 64 of the voltage dividing circuit becomes within the power supply voltage range VL of the switching element, whereas a level of such a signal “c” which is not subdivided by the voltage dividing circuit exceeds the power supply voltage range “VL” of the switching element.

Under such a circumstance, the following technical ideas are conceivable. That is, a voltage limiting circuit may be provided at the prestage of the switch circuit 43 in order that the signal level does not exceed the power supply voltage range “VL” of the switching element. Otherwise, the switch circuit 43 may be arranged by a switching element, the power supply voltage range of which is wide. However, in the case that the voltage limiting circuit is provided, there is a problem that a signal waveform is distorted while the voltage limiting operation is carried out. Also, in such a case that a switching element whose power supply voltage is high is employed, since this employed switching element does not correspond to a general-purpose switching element, there are such problems that a selection range of this switching element is narrow, and further, a cost of this switching element is increased. If a power supply voltage of a switching element is increased, then there is such a problem that an additional power supply circuit is required, since such a case is generally provided that this high power supply voltage of the switching element is different from the power supply voltage of other circuits.

Under such a technical point, as shown in FIG. 4, the signal level is attenuated by the attenuating circuit 42 so as to obtain such a signal level which does not exceed the power supply voltage of the switching element of the switch circuit 43. Then, the attenuated signal is amplified by the amplifying circuit 45, so that the relationship between the above-described signal level and the power supply voltage of the switching element of the switch circuit can be solved. However, the below-mentioned problems may occur:

(1). Since both the attenuating circuit 42 and the amplifying circuit 45 are provided, the cost is increased.

(2). The employment of both the attenuating circuit 42 and the amplifying circuit 45 cause the circuit to become complex.

(3). The characteristic is deteriorated due to the complex circuit.

An object of the present invention is to simplify the circuit arrangement so as to improve a cost down aspect.

### DISCLOSURE OF THE INVENTION

Referring now to FIG. 1 so as to explain a signal level switching circuit of the present invention, the signal level switching circuit for adjusting a signal level to input the level-adjusted signal to a reception circuit 6 is comprised of: input resistors 2a and 2b connected between input terminals 1a and 1b of the signal and output terminals 5a and 5b used to be connected to the reception circuit 6; a switch circuit 3 which has been constituted by a plurality of switching elements and has been connected to the output terminals 5a and 5b; and a voltage dividing resistor 4 for selectively switching/connecting the input resistors 2a and 2b by this switch circuit 3.

Also, the switch circuit 3 includes switching contacts “s0”, “s1” by the plurality of switching elements, and has such an arrangement that at least one switching contact is brought into an open state, and the voltage dividing resistor 4 has been connected to either another switching contact or other switching contacts. Also, the switch circuit 3 owns an arrangement that the switch circuit 3 controls the switching elements for constituting the switching contacts in accordance with a reception level judgement made in the reception circuit 6.

### BRIEF DESCRIPTION OF THE DRAWINGS

FIG. 1 is an explanatory diagram for explaining a basic idea of the present invention.

FIG. 2 is an explanatory diagram for explaining an embodiment mode of the present invention.

FIG. 3 is an explanatory diagram for explaining another embodiment mode of the present invention.

FIG. 4 is an explanatory diagram for explaining the major portion of the conventional signal level switching circuit.

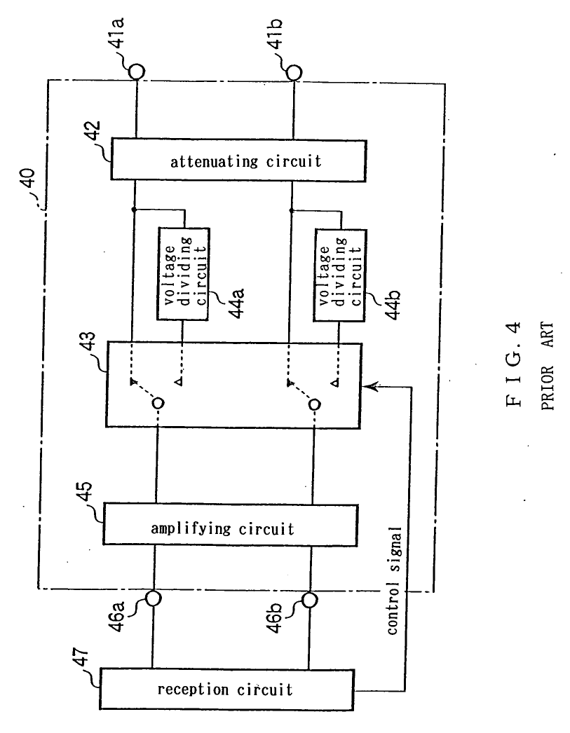

FIG. 5 is an explanatory diagram for explaining the conventional signal level switching circuit.

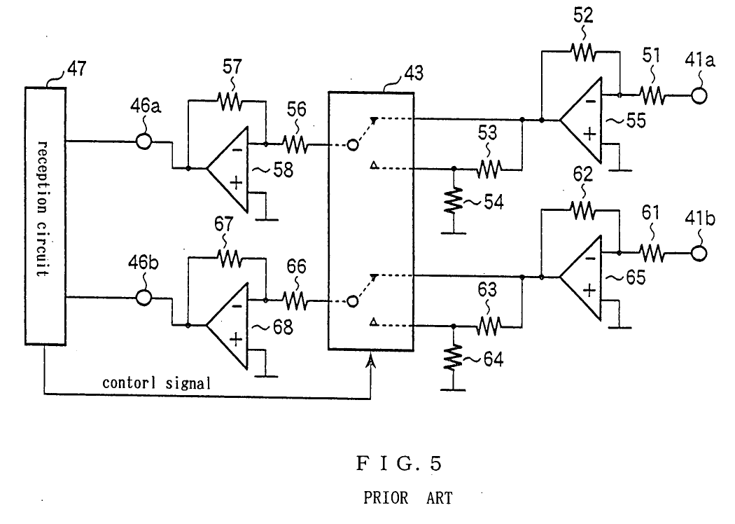

FIG. 6 is an explanatory diagram of the signal level.

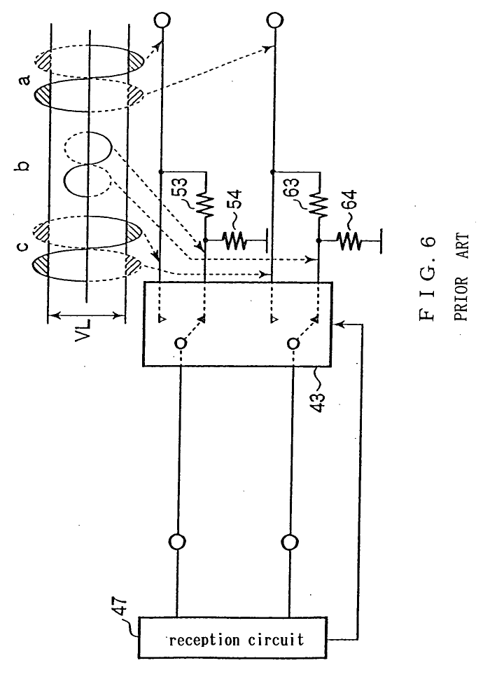

### BEST MODE FOR CARRYING OUT THE INVENTION

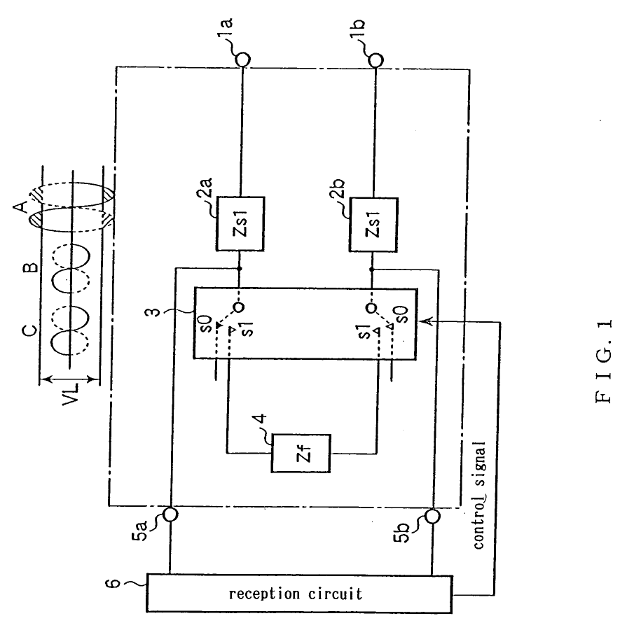

Referring now to FIG. 1, an explanation is made of a signal level switching circuit. That is, reference numerals 1a and 1b show input terminals; reference numerals 2a and 2b indicate input resistors (Zs1); reference numeral 3 represents a switch circuit; symbols “s0” and “s1” show switching contacts which are arranged by switching elements such as transistors; reference numeral 4 indicates a voltage dividing resistor (Zf); reference numerals 5a and 5b represent output terminals; and reference numeral 6 represents a reception circuit.

The input resistors 2a and 2b are connected between the input terminals 1a and 1b of the signal level switching circuit, and the output terminals 5a and 5b thereof, and the reception circuit 6 is connected to the output terminals 5a and 5b. Also, the switch circuit 3 is connected to the output terminals 5a and 5b, and the voltage dividing resistor 4 is connected to the switching contact s1 of the switch circuit 3. In other words, while the switch circuit 3 contains the switching contacts s0 and s1 which are constituted by a plurality of switching elements, the switching contact s0 has been set under open state, and the voltage dividing resistor 4 has been connected to the switching contact s1.

When a signal having a normal signal level is inputted to the input terminals 1a and 1b, the switch circuit 3 is switched to be the switching contact “s0” (namely, open state), so that the voltage dividing resistor 4 is brought into such a condition that this voltage dividing resistor 4 is cut off with respect to the input resistors 2a and 2b. As a consequence, the input signal having the normal signal level is entered via the input resistors 2a and 2b to the reception circuit 6. Since this reception circuit 6 owns a high input impedance arrangement, a signal current does not flow through the input resistors 2a and 2b. As a result, the signal entered from the input terminals 1a and 1b is inputted to the reception circuit 6 without any attenuation.

Also, a relationship between levels of signals “A”, “B”, “C”, and a power supply voltage range “VL” of a switching element is schematically shown; the signal “A” indicates a signal which is inputted to the input terminals 1a and 1b; the signal “B” represents an output signal of the input resistors 2a and 2b in the case that the voltage dividing resistor 4 is connected; and the signal “C” represents a signal appeared at both terminals of the voltage dividing resistor connected to the switch 3. For example, when the signal “A” having the signal level which exceeds the power supply voltage range VL of the switching element is entered to the input terminals 1a and 1b, the switch circuit 3 is switched/connected to the side of the switching contact “s1” in response to the control signal supplied from the reception circuit 6. As a result, the switch circuit 3 is brought into such a condition that the voltage dividing resistor 4 is connected between the input resistors 2a and 2b. As a consequence, the signal “A” is divided in correspondence with a resistance ratio of the input resistors 2a and 2b to the voltage dividing resistor 4, and for example, both the signal “B” on the input side of the switch circuit 3 and the signal “C” on the output side thereof become lower than, or equal to the power supply voltage range VL of the switching element. In other words, such a condition may be established that a signal having a level lower than, equal to the power supply voltage range “VL” is applied to the switching element of the switch circuit 3 by connecting the voltage dividing resistor 4 so as to divide the signal.

### Embodiment 1

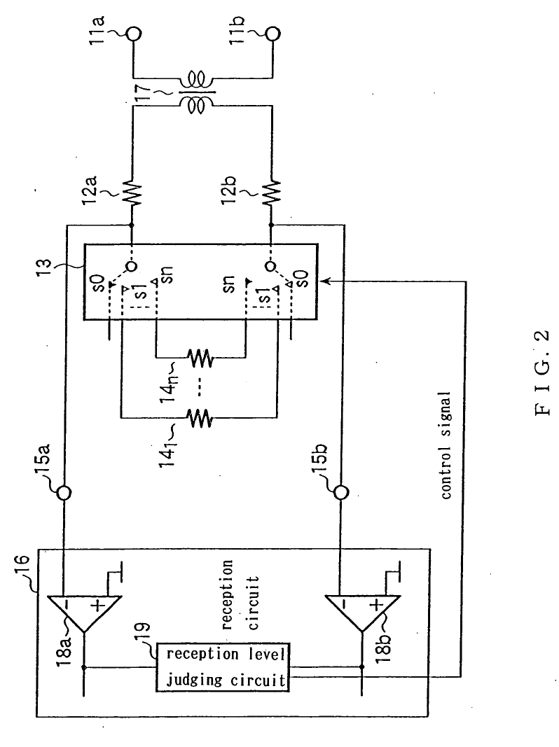

In FIG. 2, reference numerals 11a and 11b show input terminals; reference numerals 12a and 12b indicate input resistors; reference numeral 13 represents a switch circuit; symbols “s0”, “s1”, - - - , “sn” show switching contacts which are arranged by switching elements such as transistors; reference numerals 14₁ to 14ₙ show voltage dividing resistors; reference numerals 15a and 15b represent output terminals; reference numeral 16 represents a reception circuit; reference numeral 17 shows a communication transformer; reference numerals 18a and 18b indicate buffer circuits; and reference numeral 19 denotes a reception level judging circuit.

While a primary winding side of the signal transformer 17 is connected to the input terminals 11a and 11b which are connected to various sorts of transmission paths, and the like, and also, the input resistors 12a and 12b are connected to a secondary winding side of this signal transformer 17, the switch circuit 13 performs such a switching control operation that a signal obtained via the input resistors 12a and 12b is directly entered to the reception circuit 16, or a signal which has been divided by employing the voltage dividing resistors 14, to 14n is entered to the reception circuit 16 based upon a control signal supplied from the reception circuit 16.

As indicated in FIG. 1, the switch circuit 13 may be basically arranged to own 2 pieces of switching contacts. In this embodiment mode, such a case that a selective switching/connecting operation is carried out is represented. That is, while a plurality of switching contacts s0, s1, - - - , sn are constituted by a plurality of switching elements, the switching contact s0 among these contacts is set to an open state, and the voltage dividing resistors 14₁ to 14ₙ having the different resistance values are connected to other switching contacts s1 to sn, and the switching contacts are selectively switched/connected with respect to the input resistors 12a and 12b in response to a control signal produced based upon a judgement result of a signal level by the reception level judging circuit 19 of the reception circuit 16.

Also, assuming now that the resistance values of the voltage dividing resistors 14₁ to 14ₙ which are connected to the switching contacts s1 to sn of the switch circuit 13 owns a relationship defined by 14₁>14₂>14₃, - - - , >14ₙ, in such a case that a level of a signal which is inputted via the transmission path, or the like to the input terminals 11a and 11b is within the predetermined range, the signal level judging circuit 19 of the reception circuit 16 selectively switches/connects the switching contact s0 of the switch circuit 13 under open state.

In this case, it is so assumed that the signal level is present within the power supply voltage range of the switching elements of the switch circuit 13. Also, since the reception circuit 16 is brought into the high input impedance state by the buffer circuits 18a and 18b, the signal transmitted via the communication transformer 17 is directly entered to the reception circuit 16 without any attenuation caused by the input resistors 12a and 12b.

When the reception level judging circuit 19 judges that the signal level becomes high, the switch circuit 13 is controlled by the control signal in such a manner that, for example, the switching contact s0 is switched to the switching contact s1. As a result, the voltage dividing resistor 14, is brought to be connected between the input resistors 12a and 12b as to a signal level, if a code is employed as a resistance value, then a signal level (signal level inputted to the reception circuit 16) which is entered to the switch circuit 13 is reduced to 14₁/(12a+12b+14₁). As a consequence, the voltage dividing resistors may be selected in such a manner that the signal level becomes within the power supply voltage range of the switching elements of the switch circuit 13. It should be noted that when the switch circuit 13 is selectively switched/connected to the switching contact s0, since this switching contact s0 is under open state, this circuit condition is equivalent to such a case that a voltage resistor having an infinite resistance value is connected to the switch circuit 13. As previously explained, the signal is entered to the reception circuit 16 without any attenuation.

In the case that a signal level becomes maximum, if the switch circuit 13 is controlled by the reception level judging circuit 19 in such a manner that the switching contact sn is switched/connected, since the voltage dividing resistor 14n having the low resistance value is connected between the input resistors 12a and 12b, a level of a signal which is entered to both the switch circuit 13 and the reception circuit 16 may be reduced in such a manner that this signal level becomes within the power supply voltage range of the switching elements of the switch circuit 13.

As a consequence, in the case that such a signal having a level exceeding the power supply voltage of the switching elements of the switch circuit 13 is entered to the switch circuit 13, since a voltage dividing resistor having a resistance value is connected between the input resistors 2a and 2b, the signal level can be reduced to become lower than, or equal to the power supply voltage of the switching elements. Furthermore, the signal levels can be switched in such a manner that the switched signal level becomes within a desirable signal level range with respect to the reception circuit 16.

### Embodiment 2

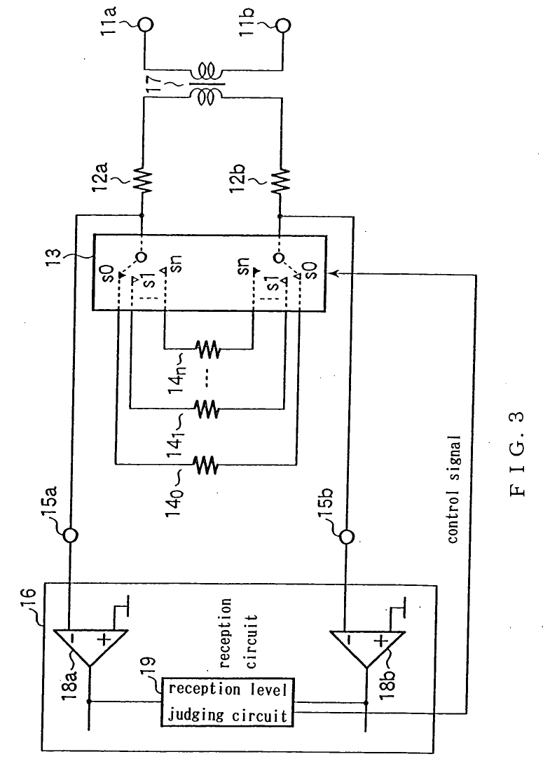

In FIG. 3, the same reference numerals shown in FIG. 2 indicate the same structural elements, and reference numeral “140” indicates a voltage diving resistor. In other words, the switching contact s0 of the switch circuit 13 is not brought into an open state, but the voltage dividing resistor 14₀ is connected the switching contact s0. In this case, resistance values of these voltage dividing resistors may have such a relationship of, for example, 14₀>14₁>14₂>14₃>, - - - , >14ₙ. In this case, if the resistance value of the voltage dividing resistor 14₀ is selected to be an infinite resistance value, then the switching contact s0 may become equivalent to the open state in FIG. 2.

### INDUSTRIAL APPLICABILITY

As previously explained, the signal level switching circuit of the present invention is provided with the input resistors 2a and 2b connected between the input terminals 1a and 1b of the signal and the output terminals 5a and 5b used to be connected to the reception circuit 6; the switch circuit 3 which is constituted by the plurality of switching elements and is connected to the output terminals 5a and 5b; and the voltage dividing resistor 4 which is selectively switched/connected with respect to the input resistors 2a and 2b by this switch circuit 3. In this signal level switching circuit, since the switch circuit 3 is controlled in correspondence with the signal level to be entered, the signal level can be reduced to such a level within the power supply voltage range of the switching element which constitutes the switch circuit 3. Also, since the signal level switching circuit can be realized by the small number of resistors and the switch circuit, there are merits that the circuit arrangement may be simplified and the cost down aspect may be improved.

1. A signal level switching circuit for adjusting a level of a signal to input the level-adjusted signal to a reception circuit, comprising:
an input resistor connected between an input terminal of the signal and an output terminal used to be connected to said reception circuit;
a switch circuit which has been constituted by a plurality of switching elements and has been connected to said output terminal; and
a voltage dividing resistor for selectively switching/connecting with respect to said input resistor by said switch circuit.

2. A signal level switching circuit as claimed in claim 1 wherein:
said switch circuit includes switching contacts by the plurality of switching elements, and has such an arrangement that at least one switching contact is brought into an open state, and said voltage dividing resistor has been connected to either another switching contact or other switching contacts.

3. A signal level switching circuit as claimed in claim 1 wherein:
said switch circuit owns an arrangement that said switch circuit controls the switching elements for constituting said switching contacts in accordance with a reception level judgement made in said reception circuit.
